(19) United States
(12) Patent Application Publication
(10) Pub. No.: US 2008/0133041 A1
(43) Pub. Date: Jun. 5, 2008

(54) METHOD AND SYSTEM FOR CONTROLLING SUBSTRATE HANDLING AT SUBSTRATE BUFFERS BY INTERRUPTING PROCESS JOBS DEPENDING ON JOB PRIORITY

(76) Inventor: Kilian Schmidt, Dresden (DE)

Correspondence Address: WILLIAMS, MORGAN & AMERSON, 10333 RICHMOND, SUITE 1100, HOUSTON, TX, 77042, US

(21) Appl. No.: 11/758,971

(22) Filed: Jun. 6, 2007

(30) Foreign Application Priority Data
Nov. 30, 2006 (DE) 10 2006 056 597.5

(51) Int. Cl. G06F 19/00

(52) U.S. Cl. 700/101

(57) ABSTRACT

By enabling an interleaved mode when supplying substrates from a system-internal buffer area to a respective process area, a reduction of non-productive time of the process tool and/or a reduction of cycle time may be achieved compared to a conventional sequential processing of carriers. Upon arrival at a substrate buffer area of the process tool, an appropriate priority may be assigned to the substrates, wherein a higher priority may enable the interruption of the processing of a lower-ranked substrate group.

### BACKGROUND OF THE INVENTION

1. Field of the Invention

Generally, the present disclosure relates to the field of fabricating products, such as semiconductor devices, in a manufacturing environment including process tools exchanging transport carriers with an automated transport system, wherein the products, such as substrates for semiconductor devices, are processed on the basis of groups defined by the contents of the transport carriers.

2. Description of the Related Art

Today's global market forces manufacturers of mass products to offer high quality products at a low price. It is thus important to improve yield and process efficiency to minimize production costs. This holds especially true in the field of semiconductor fabrication, since, here, it is essential to combine cutting edge technology with mass production techniques. It is, therefore, the goal of semiconductor manufacturers to reduce the consumption of raw materials and consumables while at the same time improve process tool utilization. The latter aspect is especially important since, in modern semiconductor facilities, equipment is required which is extremely cost-intensive and represents the dominant part of the total production costs.

Integrated circuits are typically manufactured in automated or semi-automated facilities, thereby passing through a large number of process and metrology steps to complete the device. The number and the type of process steps and metrology steps a semiconductor device has to go through depends on the specifics of the semiconductor device to be fabricated. A usual process flow for an integrated circuit may include a plurality of photolithography steps to image a circuit pattern for a specific device layer into a resist layer, which is subsequently patterned to form a resist mask for further processes in structuring the device layer under consideration by, for example, etch or implant processes and the like. Thus, layer after layer, a plurality of process steps are performed based on a specific lithographic mask set for the various layers of the specified device. For instance, a sophisticated CPU requires several hundred process steps, each of which has to be carried out within specified process margins so as to fulfill the specifications for the device under consideration. Since many of these processes are very critical, a plurality of metrology steps have to be performed to efficiently control the process flow and to monitor the performance of the respective process tools. For example, frequently, so-called pilot substrates are processed and subjected to measurement procedures prior to actually releasing the associated group of “parent” substrates in order to test the compliance with predefined process margins. Typical metrology processes may include the measurement of layer thickness, the determination of dimensions of critical features, such as the gate length of transistors, the measurement of dopant profiles and the like. As the majority of the process margins are device-specific, many of the metrology processes and the actual manufacturing processes are specifically designed for the device under consideration and require specific parameter settings at the adequate metrology and process tools.

In a semiconductor facility, a plurality of different product types are usually manufactured at the same time, such as memory chips of different design and storage capacity, CPUs of different design and operating speed and the like, wherein the number of different product types may even reach one hundred and more in production lines for manufacturing ASICs (application specific ICs). Since each of the different product types may require a specific process flow, different mask sets for the lithography, specific settings in the various process tools, such as deposition tools, etch tools, implantation tools, CMP (chemical mechanical polishing) tools and the like, may be necessary. Consequently, a plurality of different tool parameter settings and product types may be simultaneously encountered in a manufacturing environment. Thus, a mixture of product types, such as test and development products, pilot products, different versions of products, at different manufacturing stages, may be present in the manufacturing environment at a time, wherein the composition of the mixture may vary over time depending on economic constraints and the like, since the dispatching of non-processed substrates into the manufacturing environment may depend on various factors, such as the ordering of specific products, a variable degree of research and development efforts and the like. Thus, frequently the various product types may have to be processed with a different priority to meet specific requirements imposed by specific economic or other constraints.

Despite these complex conditions, it is an important aspect with respect to productivity to coordinate the process flow within the manufacturing environment in such a way that a high performance, for example in terms of tool utilization, of the process tools is achieved, since the investment costs and the moderately low “life span” of process tools, particular in a semiconductor facility, significantly determine the price of the final semiconductor devices. In modern semiconductor facilities, a high degree of automation is typically encountered, wherein the transport of substrates is accomplished on the basis of respective transport carriers accommodating a specific maximum number of substrates. The number of substrates contained in a carrier is also referred to as a lot and the number of substrates is therefore frequently called the lot size. In a highly automated process line of a semiconductor facility, the transport of the carriers is mainly performed by an automated transport system that picks up a carrier at a specific location, for example a process or metrology tool, within the environment and delivers the carrier to its destination, for instance another process or metrology tool that may perform the next process or processes required in the respective process flow of the products under consideration. Thus, the products in one carrier typically represent substrates receiving the same process, wherein the number of substrates in the carrier may not necessarily correspond to the maximum number of possible substrates. That is, the lot size of the various carriers may vary, wherein typically a “standard” lot size may dominate in the manufacturing environment. For example, one or more pilot substrates, which may be considered as representatives of a certain number of parent substrates contained in a certain number of carriers filled with the standard lot size, may be transported in a separate carrier, since they may undergo a specific measurement process and therefore may have to be conveyed to a corresponding metrology tool, thereby requiring an additional transport job. Based on the results of the measurement process, the waiting parent substrates may then be delivered to the respective process tool.

The supply of carriers to and from process tools is usually accomplished on the basis of respective “interfaces,” also referred to as load ports, which may receive the carriers from the transport system and hold the carriers to be picked up by the transport system. Due to the increasing complexity of process tools, having implemented therein a plurality of functions, the cycle time for a single substrate may increase. Hence, when substrates are not available at the tool although being in a productive state, significant idle times or unproductive times may be created, thereby significantly reducing the utilization of the tool. Thus, typically, the number and configuration of the load ports is selected such that one or more carriers may be exchanged at the load port(s) while the functional module of the process tool receives substrates from another load port to achieve a cascaded or continuous operation of the process tool. The time for the exchange of carriers between the automated transport system and the respective process or metrology tool depends on the transport capacity of the transport system and the availability of the carrier to be conveyed at its source location. Ideally, when a corresponding transport request for a specified lot currently processed in a source tool is to be served, the respective substrates should be available at the time the transport system picks up the carrier including the lot and delivers the carrier at the destination tool such that a continuous operation can be maintained. Consequently, the respective carrier should be delivered to the destination tool when or before the last substrate of the carrier currently processed in the destination tool is entered into the process module so that a continuous operation may be achieved on the basis of the newly arrived carrier. Thus, for an ideal continuous operation of a process tool, one carrier would be exchanged while another carrier is currently processed. Depending on the capacity of the tool interface, for instance the number of load ports provided, a certain buffer of carriers and thus substrates may be provided in order to generate a certain tolerance for delays and irregular deliveries. Moreover, as the actual carrier exchange time does not substantially depend on the lot size, whereas the time window for performing an actual carrier exchange is highly dependent on the respective lot size, since a small currently processed lot provides only a reduced time interval for exchanging, also referred to as a window of opportunity for carrier exchange, another carrier without producing an undesired idle time, the presence of a mixture of lot sizes, such as pilot lots, development lots and the like, or the presence of lots having a high priority may negatively affect the overall performance of process tools.

Moreover, there is the tendency to implement an increasing number of functions in a tool system, in which the substrates are substantially passed through the tool system on a single substrate basis. In this case, the carriers arriving at the load ports may not have a significant influence on the system internal transport situation, as long as continuously substrates are available from the system's load ports. That is, with a moderate increase of the capacity with respect to the system load ports, in principle, a continuous supply of the system may be achieved, wherein, however, system internal characteristics with respect to substrate transport may not be influenced. For this reason, it may be advantageous to install substrate buffers at strategically selected points within the process chain of the system to provide the potential for compensating for small mismatches in processing substrates in the various process areas of the tool system. For example, a substrate buffer may be provided between processing areas A and B, B receiving substrates from area A via the substrate buffer area. If for certain reasons, such as process delays, set up times and the like, the throughput of the processing area B may temporarily be slightly lower compared to processing area A, the buffer area may nevertheless receive processed substrates from area A while delivering substrates to area B with a slight delay, thereby allowing both areas A and B to operate in a continuous manner within the capacity limits of the buffer area. However, in this case, the presence of development lots and the like, or the presence of lots having a high priority, may also negatively affect the overall performance of the tool system, in particular when idle times for the entire tool system are required due to the expected arrival of a high priority job.

The present disclosure is directed to various systems and methods that may avoid, or at least reduce, the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the subject matter disclosed herein is directed to a technique that provides enhanced flexibility for processing substrates when different groups of substrates are to be processed in a plurality of process areas, wherein at least two of the plurality of process areas are connected by a substrate buffer area. Contrary to conventional techniques in which a specific group of substrates is processed in a continuous non-interrupted manner, referred to as a job, wherein at least all substrates contained in a specific substrate carrier are entered into the process area prior to supplying the substrates of another group into the respective process area, the subject matter disclosed herein enables an “interleaved” supply of substrates to respective process areas depending on the specific process conditions at the plurality of process areas. In this way, the supply of substrates of one group or lot may be interrupted at any appropriate point in time and one or more substrates of one or more other lots may be intermittently supplied according to the specific process requirements. Consequently, the overall tool utilization may be enhanced and cycle time reduced for various process conditions, such as the presence of very different lot sizes and/or the processing of lots representing substrates of high priority and the like.

According to one illustrative embodiment disclosed herein, a tool controller comprises a job priority estimator configured to receive process information that at least indicates a current status of a substrate buffer unit of a process tool or a process tool system, wherein the job priority estimator is further configured to determine, on the basis of the current status, a first process priority for a currently processed job and a second process priority for a job to be processed in the process tool or process tool system. The tool controller further comprises a job management unit connected to the job priority estimator and configured to interrupt the currently processed job when the first process priority is lower than the second process priority.

According to another illustrative embodiment disclosed herein, a process tool system comprises a first process area configured to process a plurality of substrates and a second process area configured to process substrates processed by the first process area. The process tool further comprises a first substrate buffer unit configured to temporarily store substrates received from the first process area and to supply substrates to the second process area. Moreover, a control unit is provided and connected to the substrate buffer unit, wherein the control unit is configured to supply substrates from at least two groups of substrates processed by the first process area to the second process area in an interleaved manner on the basis of at least one of a status of the substrate buffer unit and a priority of substrates of the at least two groups.

According to yet another illustrative embodiment disclosed herein, a method comprises supplying substrates from a plurality of substrate groups to a process area of a process tool via a substrate buffer unit, wherein the process tool exchanges substrates with a manufacturing environment. Furthermore, the method comprises temporarily interrupting the supply of substrates belonging to a first group to the process area and supplying at least one substrate belonging to a second group to the process area when a priority of the first group is less than a priority of said the group.

### BRIEF DESCRIPTION OF THE DRAWINGS

The disclosure may be understood by reference to the following description taken in conjunction with the accompanying drawings, in which like reference numerals identify like elements, and in which:

FIG. 1a schematically illustrates a manufacturing environment comprising an automated transport system and a process tool including an interface for substrate carrier exchange, a plurality of process areas with an intermediate substrate buffer unit and a process controller enabling an “interleaved” supply of substrates from at least two different substrate groups to at least one of the process areas according to illustrative embodiments disclosed herein;

FIG. 1b schematically illustrates a time diagram representing an operational mode of processing pilot and parent lots on the basis of system internal job prioritizing according to illustrative embodiments disclosed herein compared to a conventional tool behavior; and

FIGS. 1c-1d schematically illustrate tool systems using system internal substrate buffer units that are controlled to enable job interruption upon job priority according to illustrative embodiments.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the subject matter disclosed herein relates to a technique for enhancing tool and cycle time performance in a manufacturing environment for specific process conditions, in which transport related issues and/or process requirements may result in performance degradation in conventional strategies for handling the substrate transfer to and from a specific process area. In conventional techniques, substrates may, at least temporarily, be grouped into specific entities which require, at least for a part of the entire process flow, to be passed through one or more process steps. In this case, the respective substrates may be positioned in a respective transport carrier, or in several carriers, when the number of substrates belonging to the specific group exceeds the capacity of a single substrate carrier. In complex manufacturing environments, such as semiconductor facilities and the like, the process flow for completing the devices may require a large number of process steps, as previously described, wherein the group of substrates has to be passed through a plurality of process tools or systems of process tools, which may be understood as a plurality of process areas connected by an internal substrate handling system, in a time-efficient manner, while at the same time ensuring a high degree of tool efficiency of the respective process tools. Typically, the substrate carriers are conveyed within the manufacturing environment on the basis of an automated transport system, which “communicates” with the respective process tools via appropriate interfaces, that is, load ports which in turn are connected to a tool internal interface or substrate handling system for exchanging individual substrates between the load ports and the actual process areas, depending on the complexity of the respective process tool. The conventional strategy, that is, supplying all substrates of a specific carrier to a specified process area while exchanging another carrier with the automatic transport system so as to provide further substrates for the processing in the specified process module, may result, under certain process conditions, in a significant loss of tool performance. For example, in some cases, a certain amount of substrates may have to be processed at some or all process tools in the manufacturing environment with high priority without tolerating significant waiting times at the several process tools. Thus, corresponding groups of substrates or lots arriving at the specific process tool may need to be immediately processed by the process tool. In the conventional technique, the corresponding process tool may currently process a specific carrier or substrate group, which according to the conventional techniques may not be interrupted until the respective job, i.e., the processing of the respective group of substrates, is completed. Consequently, a dedicated process tool has to be maintained in an idle state, when a corresponding lot of high priority substrates, sometimes referred to as rocket lot, is scheduled for a certain process step. Consequently, since the entire processing in the manufacturing environment may be highly dynamic, the respective process tool has to be reserved over an extended time interval, in which the arrival of the lot of high priority is expected, thereby contributing to a high amount of unproductive time for the process tool under consideration. This may result in a very high loss of throughput, when the corresponding tool or system comprises a plurality of sequentially arranged process areas so that all areas may have to maintained in the idle state.

In other cases, the presence of small lots may prevent a proper cascading of operation of the respective process tool, as previously described, since the window of opportunity for exchanging carriers with the automated transport system may be reduced compared to the situation of continuously processing substrate lots of standard size. A similar situation occurs when pilot substrates, which may be considered as a small lot to be processed prior to the parent lot, arrive at a specific tool or process area and may have to wait until the currently processed group is completed, thereby also significantly delaying the further processing of the parent lot.

Consequently, the subject matter disclosed herein provides significantly increased flexibility since the supply of substrates to the process areas of a respective process tool or system via intermediate substrate buffer units, which are areas in which substrates may be temporarily stored between respective processes to be performed in respective process areas, may be controlled on the basis of process and/or substrate requirements, since a currently processed job may be interrupted at any appropriate point in time in order to allow the insertion of one or more substrates of other jobs. For instance, in the above-described case of lots of high priority, a currently processed job may be immediately interrupted as soon as substrates of a corresponding lot of high priority arrive at a respective substrate buffer unit, thereby substantially avoiding any idle times of the process areas while nevertheless guaranteeing timely processing of the lots of high priority. In other cases, when a group of reduced lot size arrives at the specific substrate buffer unit, the current processing of a standard lot size job may be interrupted at any appropriate time in order to process the small lot size, which may then be efficiently forwarded to other processes, such as metrology, while the processing of the previously interrupted job is resumed, thereby reducing the overall cycle time of, for instance, specific lots that may be correlated to the small size lot. For this purpose, in some illustrative embodiments, each group arriving at the substrate buffer unit is assigned a dedicated priority, which may be based on an externally assigned priority of the respective substrates and/or which may be determined on the basis of specific process conditions, i.e., on the basis of jobs currently processed in the process areas connected to the substrate buffer unit, the lot size of the currently processed job and the newly arriving job, the buffer capacity of the buffer unit and the like. Based on the corresponding priorities of the various jobs currently processed or to be processed in the respective process area, it may be decided whether or not and when a currently being processed job having a lower priority is to be interrupted and a respective job of higher priority is performed intermittently. In some cases, the priority assigned to each job may be established on the basis of various criteria, such as priority of the respective substrates, such as rocket lots, total cycle time of specific lots, tool utilization and the like. Moreover, in some illustrative embodiments, the corresponding priorities may be dynamically changed depending on specific process situations. For instance, during a certain phase, the reduction of cycle time of specific lots may be favored at the cost of a somewhat reduced overall tool utilization, while, in other production phases, a maximum tool performance may be the decisive criterion for assigning respective priorities to the respective lots arriving at specific process tools.

It should be appreciated that the subject matter disclosed herein is particularly advantageous in the context of complex manufacturing environments as are typically encountered in facilities for fabricating microstructure devices, such as integrated circuits and the like, since here a plurality of different product types are to be processed in a highly complex manufacturing environment. The principles disclosed herein may, however, also be applied to any complex manufacturing environment in which automated material transport to a plurality of different process tools and within the tools based on tool-internal substrate buffering is employed. Consequently, the present invention should not be considered as being restricted to semiconductor facilities, unless such restrictions are explicitly set forth in the specification and/or the appended claims.

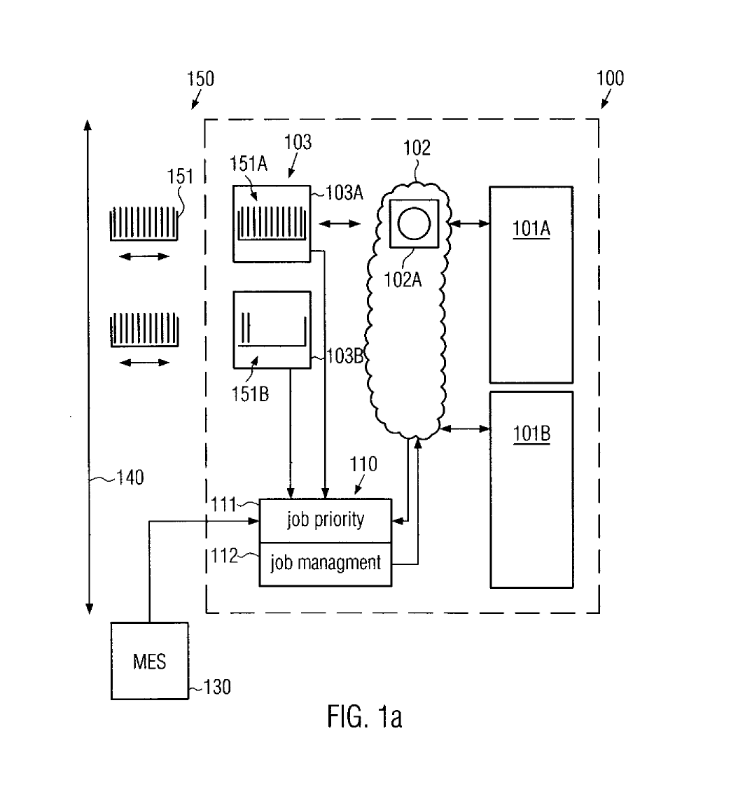

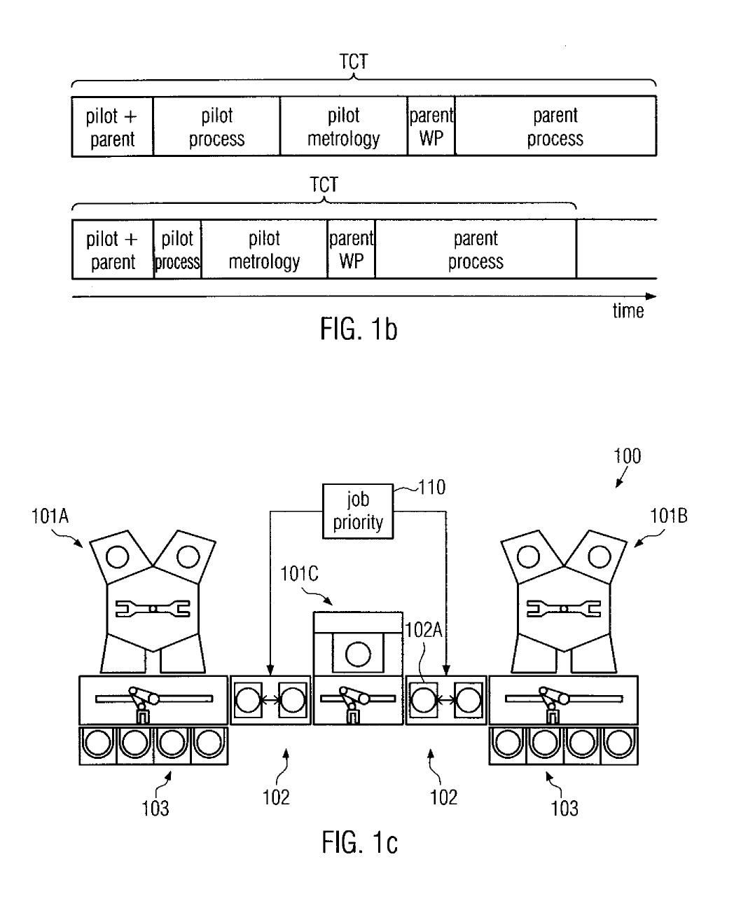

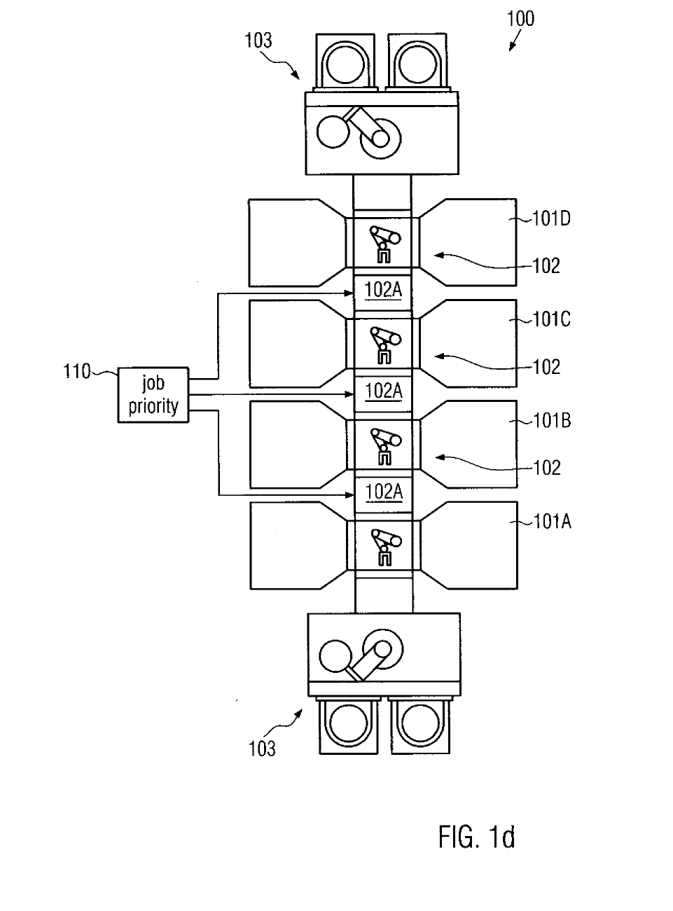

FIG. 1a schematically illustrates a manufacturing environment 150 which, in one illustrative embodiment, may represent a manufacturing environment for the fabrication of semiconductor devices, such as integrated circuits, micromechanical devices, micro-optical devices and the like. It should be appreciated that the term “semiconductor device” is to be understood as a generic term for any device being formed on the basis of microelectronic and/or micromechanic manufacturing techniques. The manufacturing environment 150 may comprise an automated transport system 140, which is configured to pick up, convey and dispatch carriers 151, depending on a predefined schedule. For instance, in semiconductor facilities, the automated transport system 140, also referred to in this case as an automated material handling system (AMHS), is configured to pick up appropriate transport carriers, such as FOUP (front opening unified pods) and the like, which are typically configured to accommodate a specific maximum number of substrates. For instance, in many semiconductor facilities, the respective carriers 151 are configured to contain 25 substrates. It should be appreciated that the maximum number of substrates that may be contained in a single carrier 151 may not necessarily represent the standard lot size, which may be selected on a basis of company-internal constraints and the like. The automated transport system 140 may further be configured to exchange the carriers 151 with a plurality of process tools 100 within the environment 150, wherein, for convenience, a single process tool is illustrated. For this purpose, the process tool 100 may comprise a carrier exchange interface 103, which may be configured to receive a plurality of carriers 151 from the system 140 and hold respective carriers 151 for being picked up by the system 140, when the processing of the respective substrates in the carriers 151 within the tool 100 is completed. In some illustrative embodiments, the respective carrier exchange interface 103 may comprise a plurality of load ports 103A, 103B which may represent respective tool stations in which the system 140 may deliver a carrier 151 including substrates to be processed and may pick up a carrier 151 including substrates processed within a process module 101, which may, depending on the complexity of the tool 100, comprise a plurality of individual process areas 101A, 101B. It should be appreciated that the number of load ports 103A, 103B may depend on the configuration of the tool 100, wherein an increased number of load ports may provide an increased carrier exchange capability at the expense of increased tool complexity, tool size and tool costs.

The process tool 100 may further comprise a tool-internal substrate handling system 102 including a substrate buffer unit 102A, which may represent a substrate handling system, such as a robot handler that is configured to receive substrates, for instance from the load ports 103A, 103B, and supply the substrates to the process areas 101A, 101B, and return processed substrates into the respective carriers in the load ports 103A, 103B. The buffer unit 102A provides a defined capacity for storing individual substrates prior to and/or after processing in one or more of the process areas 101A, 101B. The buffer unit 102A may therefore act as buffer for substrates for the tool-internal transport paths, in which the substrates may be handled after being removed from the carriers 151 used for the tool-external transport of substrates by using the transport system 140. Furthermore, the process tool 100 may comprise a controller 110, which, in one illustrative embodiment, may represent an integral part of the tool 100, while in other embodiments the controller 110 may be external to the tool 100 and may be operatively connected thereto in order to perform the respective transport-related control function. The controller 110 may be configured to control the operation of the substrate handling system 102 on the basis of process information indicating the current tool status so as to coordinate the supply of substrates from two or more different groups of substrates, which may arrive in respective carriers placed on the respective load ports 103A, 103B, to the process areas 101 in an interleaved mode, if required, while storing respective non-supplied substrates in the substrate buffer unit 102A. In one illustrative embodiment, the controller 110 may comprise a job priority estimator 111, which is operatively connected to at least the substrate handling system 102, and, in the embodiments shown, also to the carrier exchange interface 103, so as to receive process information regarding at least the status of the handling system 102 including the unit 102A and/or the status of substrates contained therein. The job priority estimator 111 may be configured to extract a corresponding status of the handling system 102 from the respective process information and to assign an appropriate priority to each of the groups of substrates positioned in the handling system 102. For example, each newly arriving group of substrates 151A, 151B may be assigned a specific priority on the basis of an externally assigned priority of the substrates belonging to the groups 151A, 151B, and/or the number of substrates of each group 151A, 151B, and/or on the basis of the number of substrates presently stored in the substrate buffer unit 102A and the like. The external priority of substrates may be established or stored in a manufacturing execution system (MES) 130, or any other source and may be communicated to the job priority estimator 111 for further evaluation.

For instance, if a carrier 151 arrives at the load port 103B in which a small number of substrates may be contained, such as a single substrate representing a pilot, a qualification lot and the like, the respective carrier or group contained therein may receive a higher priority compared to other lots or groups presently processed in the tool 100 and partially stored in the buffer unit 102A when representing a lot of greater size or standard size. In other cases, the job priority estimator 111 may identify an externally assigned priority of the substrate, for instance if the substrates are indicated as a rocket lot that is to be processed immediately after arrival at the process tool 100. Consequently, the estimator 111 may establish a specific hierarchy of the lots within the handling system 102, that is, within the buffer unit 102A on the basis of the respective priorities. In some illustrative embodiments, the priorities of groups or even individual substrates already present in the buffer unit 102A may receive updated priority values by the job priority estimator 111 when a new group arrives and/or when the process situation may change and may require, for instance, an accelerated or delayed handling of a specific lot.

It should be appreciated that, in some embodiments, the priority of the groups of substrates 151A, 151B may, in a similar manner, be assigned to carriers 151 in the interface 103, which may be considered as a “carrier buffer unit.” Hence, the estimator 111 may assign a priority to each carrier 151 and each newly arriving carrier on the basis of similar criteria, as discussed above with respect to the system 102 including the substrate buffer unit 102A. These priorities may be used as “base” or “input” priorities in determining respective group or substrate priorities for operating the handling system 102 with respect to supplying substrates to the process areas 101A, 101B, thereby temporarily storing substrates in the buffer unit 102A on the basis of the priorities specifically determined with respect to the process situation in the buffer unit 102A. For example, the priority of a newly arriving carrier 151 may be very high, requiring immediate processing, that is, delivery to one of the areas 101A, 101B. However, after several tool cycle times, certain events may demand a different or significantly lower priority of the group under consideration. In this case, the estimator 111 may dynamically update the priority and may instruct the system 102, which may contain the substrates at least partially in the buffer unit 102A, to proceed with the updated priority, thereby possibly prioritizing other substrates within the buffer 102A which may have been delayed in favor of the previously high priority group.

Moreover, in one illustrative embodiment, the controller 110 may further comprise a job management unit 112, which is connected to the estimator 111 and is configured to determine, on the basis of the respective hierarchy established by the estimator 111, an appropriate operational mode for the internal substrate handling system 102 for exchanging substrates between the buffer unit 102A and the process areas 101A, 101B. For this purpose, the job management unit 112 may be configured to instruct the respective components of the system 102 for supplying substrates to the areas 101A, 101B according to the determined operational mode, for instance a sequential mode, in which all the substrates of a group are supplied to the areas 101A, 101B before a substrate of a next group is supplied to the areas 101A, 101B, or in an interleaved mode wherein, prior to supplying all substrates of one group, at least a substrate of a different group is supplied to the process areas 101A, 101B, while storing the delayed substrates in the buffer unit 102A.

During operation of the process tool 100 in the manufacturing environment 150, the system 140 may exchange the carriers 151 with the interface 103, wherein a corresponding carrier exchange time may typically take several minutes until a carrier 151 ready to be picked up by the system 140 is actually picked up by the system 140 and until a new carrier 151 is delivered to the respective load port. For convenience, it may be assumed that a carrier 151 of standard lot size or other lot sizes are currently processed in the load port 103A, that is, the respective substrates therein, which may be considered as being delivered via the tool internal handling system 102 to the process areas 101A, 101B, while a carrier including a group 151B is arriving at the load port 103B, which may comprise, for instance, a small lot such as a pilot lot, a qualification lot, a development lot and the like. For instance, the second group 151B may include a single substrate. Upon arrival, the job priority estimator 111 may receive corresponding process information indicating, in one illustrative embodiment, an externally assigned priority of the lot in the carrier 151B, the size of the lot and the like. Based on the respective process information, the estimator 111 may determine a priority for the group 151B, for instance on the basis of predefined criteria. For instance, the estimator 111 may operate on the basis of a general rule based on the concept of maintaining a high tool utilization. In this case, the estimator 111 may first check the internal priority of the group 151B to identify any substrates that need to be processed with high priority as dictated by an externally assigned high priority. If, for example, a corresponding priority value is substantially identical to the priority values of the substrates currently processed, that is, if, for instance, a rocket lot or the like is not identified, the estimator 111 may assign the group 151B a corresponding priority on the basis of the lot size, wherein, in the present example, the priority may be higher compared to the standard lot size. A higher priority for smaller lot sizes may be assigned in order to increase tool utilization.

Thus, when the group 151B arrives at the buffer unit 102A, the estimator 111 may assess the priority of the arriving group 151B using the initial high priority due to the small lot size and may also assess the present status of the buffer unit 102A, for instance with respect to its remaining capacity, the number of substrates of a previous group still to be processed and the like. If the currently determined priority of the arriving group 151B may be higher than the priority of the currently processed group and any group possibly stored in the buffer unit 102A, the supply of the currently processed group may be interrupted, and the group 151B may be supplied to the respective process area 101A, 101B.

FIG. 1b schematically illustrates a corresponding time diagram for an operational mode without interleaved substrate supply (upper portion) and a process mode according to the present disclosure (lower portion). In a first time interval, the pilot lot and the parent lot may wait for processing and thereafter the pilot lot may arrive at the system 102 for processing in the process areas 101A, 101B, while a standard lot size may currently be processed. It should be appreciated that the status of the pilot and parent lot may not necessarily have been initially established but may have changed within the tool 100. For example, after arriving at the tool 100 as a standard lot, process conditions may require at least one of the substrates to be measured prior to actually releasing the remaining substrates. Depending on the point in time of arrival at the buffer unit 102A of the system 102, up to 25 substrates, if a standard lot size of 25 is assumed, may be processed prior to passing the pilot lot through the areas 101A, 101B. For instance, for a single substrate in the pilot lot, up to 25 substrate cycles may be required upfront processing the pilot lot. Thereafter, the pilot lot is subjected to measurement and after receiving the results the parent lot may be released. Depending on the process situation at the buffer unit 102A, the parent lot may have to wait for processing and subsequently the actual process sequence may be performed, resulting in an overall cycle time (TCT) for pilot plus parent lot as indicated in FIG. 1b. Contrary thereto, after the pilot lot has arrived at the tool 100 or the buffer unit 102A, the lot may be immediately processed on the basis of the process strategy described above, thereby significantly reducing the pilot process interval, as indicated in FIG. 1b in the lower portion. Thereafter, the metrology processes and the further processes may be performed in a similar fashion as described above, thereby resulting in a significant reduction of the overall cycle time (TCT) of the pilot and parent lot. It should be appreciated that, due to the moderately long time interval for measuring the pilot lot and waiting for the metrology results, the start of processing of the parent lot is typically substantially independent from the previous processing of the pilot lot, so that the previously gained reduction of cycle time of the pilot lot may be maintained, thereby typically contributing to a reduction of the overall cycle time of the respective process sequence.

In the embodiment described with reference to FIG. 1a, the process areas 101A, 101B may represent a single process path for performing a process sequence, wherein a certain degree of decoupling with respect to throughput mismatch of the areas 101A, 101B may be achieved by the buffer unit 102A, which may be operated in a job interruption mode. In other illustrative embodiments, the two or more process areas 101A, 101B may be provided as equivalent areas, which may be served in parallel by the tool-internal system 102, wherein the buffer unit 102A may provide substrate buffering for both areas 101A, 101B. In this case, an interleaved operational mode may also be used, wherein, in one illustrative embodiment, one of the currently processed jobs having the lowest priority may be interrupted upon arrival of a job having or receiving a higher priority, for instance a higher externally-assigned priority or a specific priority as assigned by the job priority estimator 111 on the basis of the current process situation, for instance the lot size and the like. In this way, only the cycle time of the job having the lowest priority may be increased for the benefit of an enhanced tool performance and/or a reduced cycle time, as is previously explained. In still other illustrative embodiments, the respective priorities of jobs currently processed in parallel may be dynamically adapted, for instance for otherwise initially identical priorities of the currently processed jobs, upon arrival of a job of small lot size. For example, one of the currently processed jobs that has the highest number of substrates still to be processed may be assigned the lowest priority.

FIG. 1c schematically illustrates the tool 100, which may represent a tool system, in which a plurality of process areas, such as the areas 101A, 101B, are connected with a further process area 101C. The areas 101A, 101B may be connected to respective carrier exchange interfaces 103, as are described with reference to FIG. 1a. Furthermore, the substrate handling system 102 may be configured to operatively connect each of the areas 101A, 101B with the area 101C, wherein the respective buffer units 102A provide decoupling and job prioritizing as is described above. Thus, the respective handling systems 102 are controlled by the controller 110. Consequently, during operation of the system 100 of FIG. 1c, the supply of substrates to the area 101C may be based on respective job priorities.

FIG. 1d schematically illustrates the tool 100 in the form of a tool system according to another illustrative embodiment. The system 100 may here represent a substantially linear process flow of a plurality of process areas 101A, 101B, 103C, 101D, wherein between respective two of the areas 101A, 101B, 101C, 101D, a corresponding substrate handling system may be provided, wherein at least one of these systems may be configured as is described above. The areas 101A, 101B, 101C, 101D may represent a combination of a plurality of sub-areas, which may be supplied by the respective preceding system-internal transport system. That is, at least one system 102 having implemented therein the buffer unit 102A may be provided so as to provide the enhanced tool and cycle time performance, as previously described. In the embodiment shown, the system 102 may be provided between each of the areas 101A, 101B, 101C, 101D, thereby providing a high degree of flexibility in coordinating the process flow on the basis of specific criteria, such as throughput optimization, reducing idle times upon rocket lot processing and the like, for each individual process area 101A, 101B, 101C, 101D. Thus, by implementing a significant portion of a process flow into the system 100 of FIG. 1d, the amount of carrier transport activities may be significantly reduced and may be replaced by respective tool-internal substrate transport performed by the one or more handlings systems 102. By providing at least at some point in the system 100 the handling system 102 having the substrate buffer capability, the prioritizing or interrupted job processing may be efficiently implemented, irrespective of the “length” of the process flow represented by the system 100. Hence, the concept of job prioritizing, which may also be applied in providing substrates directly from the carrier exchange interface 103 to the tool-internal process areas, when tool-internal substrate buffer functionality is not available, may therefore also be established for any configuration of tools or tool systems, independent from carrier-based transport as long as substrate buffer areas are provided within the tool-internal transport paths.

As a result, the subject matter disclosed herein provides an enhanced technique for operating a tool-internal substrate handling system in that the substrate supply to and from different process areas may be performed in an interleaved mode depending on the specific process condition. In this way, the supply of substrates from a system-internal buffer area may be interrupted in order to supply substrates having a higher priority, which may represent high priority substrates that have to be processed immediately after arrival at the system-internal buffer area, substrates of small lot size, which may otherwise result in increased non-productive idle times of the process tool, and the like. For instance, upon arrival of a rocket lot, the processing of a specific group may be immediately interrupted and may be resumed after the processing of all substrates of the rocket lot. In this way, the reservation of precious tool capacity while awaiting the rocket lot may be substantially avoided. In other cases, small lots, such as test and development lots, pilot lots, qualification lots and the like, may be processed in an interleaved mode, thereby reducing or even avoiding any non-productive times of the respective process areas.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A tool controller, comprising:
a job priority estimator configured to receive process information at least indicating a current status of a substrate buffer unit connecting process areas of a process tool system, and to determine, on the basis of said current status, a first process priority for a currently processed job and a second process priority for a job to be processed in said process tool, the currently processed job comprising at least one first substrate conveyed in a first dispatch carrier configured to carry a plurality of substrates into the substrate buffer, and the job to be processed comprising at least one second substrate conveyed in a second dispatch carrier configured to carry a plurality of substrates into the substrate buffer; and
a job management unit in communication with said job priority estimator and configured to interrupt said currently processed job when said first process priority is lower than said second process priority.

2. The tool controller of claim 1, wherein said job management unit is further configured to start said job to be processed and resume said interrupted job after completion of said job having the second priority.

3. The tool controller of claim 1, wherein said job priority estimator is further configured to estimate a process priority of a plurality of jobs currently processed in said process areas on the basis of said current status, each of the plurality of jobs currently processed in said process areas comprising at least one substrate conveyed in a dispatch carrier configured to carry a plurality of substrates into the substrate buffer, and wherein said job management unit is configured to interrupt one or more of said plurality of jobs when the process priority of said one or more jobs is lower than said second process priority.

4. The tool controller of claim 3, wherein said job management unit is further configured to initiate processing of at least a part of the plurality of substrates of said job having the second process priority prior to resuming one or more of said interrupted jobs.

5. The tool controller of claim 4, wherein said job management unit is configured to select a job having the highest process priority of said one or more jobs.

6. The tool controller of claim 1, wherein said job priority estimator is further configured to estimate the first and second process priorities on the basis of a lot size of said currently processed job and said job to be processed, each lot size indicating the number of substrates in the first and second dispatch carriers, respectively.

7. A process tool system, comprising:
a first process area configured to process substrates;
a second process area configured to process substrates processed by the first process area;
a first substrate buffer unit configured to temporarily store substrates received from said first process area and to supply substrates to said second process area; and
a control unit in communication with said first substrate buffer unit, said control unit being configured to initiate said substrate buffer unit to supply substrates from at least two groups of substrates processed by said first process area to said second process area in an interleaved manner on the basis of at least one of a status of said substrate buffer unit and a priority of substrates of said at least two groups, each group comprising a plurality of substrates conveyed into the substrate buffer by a dispatch carrier.

8. The process tool system of claim 7, further comprising a third process area and a second substrate buffer unit configured to supply substrates to said third process area, wherein said control unit is further configured to supply substrates belonging to different groups of substrates to said third process area in an interleaved manner on the basis of at least one of a status of said second substrate buffer unit and a priority of substrates of said different groups, each group comprising a plurality of substrates conveyed into the second substrate buffer by a dispatch carrier.

9. The process tool system of claim 7, wherein said control unit is configured to interrupt the supply of substrates belonging to a first one of said at least two groups and to start the supply of substrates belonging to a second one of said at least two groups when a process priority of said second group is higher than a process priority of said first group.

10. The process tool system of claim 9, wherein said control unit is further configured to determine the process priority of said at least two groups on the basis of process information obtained from a source external to said tool system.

11. The process tool system of claim 7, further comprising a first carrier exchange interface operatively connected to said first process area and configured to receive dispatch carriers.

12. The process tool system of claim 11, further comprising a third process area including a second carrier exchange interface, wherein said first substrate buffer unit is configured to exchange substrates between said second and third process areas.

13. The process tool system of claim 7, further comprising a first carrier exchange interface for supplying substrates towards said first process area, and a second carrier exchange interface for receiving substrates after being processed in said second process area.

14. A method, comprising:
supplying substrates from a plurality of substrate groups to a process area of a process tool via a substrate buffer unit, the substrate buffer unit receiving the substrates in a plurality of dispatch carriers that each hold substrates from one of the plurality of substrate groups, said process tool exchanging substrates with a manufacturing environment; and
temporarily interrupting the supply of substrates belonging to a first group to said process area and supplying at least one substrate belonging to a second group to said process area when a priority of said first group is less than a priority of said second group.

15. The method of claim 14, further comprising determining said priority of the first and second groups on the basis of process information related to an operational status of said substrate buffer unit.

16. The method of claim 14, wherein said priority is determined by a priority level assigned to at least one of said first and second groups by an external source.

17. The method of claim 14, wherein all substrates of said second group are supplied to said process area prior to resuming supply of substrates of said first group.

18. The method of claim 14, further comprising determining a process priority for at least a first substrate of a further group newly arriving at said substrate buffer unit in a dispatch carrier and selecting said second group on the basis of the determined process priorities.

19. The method of claim 18, wherein said process priority for each newly arriving group is determined on the basis of a number of substrates in the dispatch carrier of each newly arriving group.

20. The method of claim 14, further comprising simultaneously supplying substrates from another group to a second process area and temporally interrupting supply of substrates of said another group and supplying at least one substrate from said second group to said second process area.
